(19) United States
(12) Patent Application Publication
(10) Pub. No.: US 2013/0238669 A1
(43) Pub. Date: Sep. 12, 2013

(54) Using Target Columns in Data Transformation

(71) Applicants: Xiaofan Zhou, Cupertino, CA (US); Wu Cao, Redwood City, CA (US); Freda Xu, Cupertino, CA (US); Andrey Belyy, Sunnyvale, CA (US)

(72) Inventors: Xiaofan Zhou, Cupertino, CA (US); Wu Cao, Redwood City, CA (US); Freda Xu, Cupertino, CA (US); Andrey Belyy, Sunnyvale, CA (US)

(73) Assignee: BUSINESS OBJECTS SOFTWARE LTD, Dublin (IE)

(21) Appl. No.: 13/416,850

(22) Filed: Mar. 9, 2012

(51) Int. Cl. G06F 17/30

(52) U.S. Cl. 707/803; 707/E17.005

(57) ABSTRACT

A data transform leverages a known hierarchy within a target data structure, in order to improve query and mapping capabilities and enhance performance. Where a target data structure is hierarchical, output data of that target data structure is often built in the document order of the nodes in the structure (from top down and from left to right). Hence, when the data for a child node in the target structure is being built, the data for the parent nodes of the child node has been built. Embodiments utilize this available portion of the target data in the form of target columns, to increase processing efficiency of the transformation process. Use of target columns according to embodiments may also allow powerful and concise expression of mapping logic in the transform, facilitating the use of functions such as selection (e.g. Where clauses), uniqueness (e.g. DISTINCT), ordering (Order By, Group By), and Aggregation.

### BACKGROUND

The present invention relates to computing, and in particular, to a systems and methods for transforming data between different data structures, for example as may be stored in databases or XML files.

Unless otherwise indicated herein, the approaches described in this section are not prior art to the claims in this application and are not admitted to be prior art by inclusion in this section.

There are products currently available for data query, integration, or transformation. A typical job performed by these products involves one or more data transforms, such as a chain or a graph of transforms.

Traditionally, each transform performs one unit of work. That is, each of the transforms takes one or more input data sets, and produces one corresponding output data set. In such a conventional data transform, the output columns of the transform are mapped to one or more source columns In such approaches, output columns tend to be considered as the result or “target” of the data transform. These output columns are usually not reused as inputs in the same transform.

Where, however, a target data structure is hierarchical in nature, such an approach can increase complexity in expressing mapping logic and lead to redundant processing. This is because data that is already available from a parent node may need to be recalculated in order to build a child node.

The present disclosure addresses these and other issues with systems and methods allowing the use of target columns in data transformation to a hierarchical target structure.

### SUMMARY

A data transform leverages a known hierarchy within a target data structure, in order to improve query and mapping capabilities and enhance performance. Where a target data structure is hierarchical in nature, the output data of that target data structure is often built in the document order of the nodes in the structure, that is, from top down and from left to right. Hence, when the data for a child node in the target structure is being built, the data for the parent nodes (ancestor nodes) of the child node has been built. Embodiments utilize this available portion of the target data in the form of target columns, to increase processing efficiency of the transformation process. Use of target columns according to embodiments may also allow powerful and concise expression of mapping logic in the transform, facilitating the use of functions such as selection (e.g. Where clauses), uniqueness (e.g. DISTINCT), ordering (Order By, Group By), and Aggregation.

An embodiment of a computer-implemented method, comprises, providing data stored according to a source data structure including a source column, and providing a hierarchical target data structure including a target column A data transform engine is caused to perform a transform on the data and the target column to build a target node of the hierarchical target data structure. The target node is stored according to the hierarchical target data structure.

An embodiment of a computer system comprises one or more processors, and a software program executable on said computer system. The software program is configured to receive data stored according to a source data structure including a source column, and to receive a hierarchical target data structure including a target column The computer program is configured to cause a data transform engine to perform the transform on the data and the target column to build a target node of the hierarchical target data structure, and configured to store the target node according to the hierarchical target data structure.

An embodiment of a non-transitory computer readable storage medium embodies a computer program for performing a method. The method comprises receiving data stored according to a source data structure including a source column, and receiving a hierarchical target data structure including a target column A data transform engine is caused to perform the transform on the data and the target column to build a target node of the hierarchical target data structure. The target node is stored according to the hierarchical target data structure.

In certain embodiments, a logic of the transform may be expressed using the target column and the source column.

According to some embodiments, the target column is included in a selection function, a uniqueness function, an ordering function, or an aggregate function.

In particular embodiments the selection function comprises a Where clause.

In certain embodiments, the uniqueness function comprises a DISTINCT clause.

In some embodiments, the uniqueness function comprises an ORDER BY clause.

The following detailed description and accompanying drawings provide a better understanding of the nature and advantages of the present invention.

### BRIEF DESCRIPTION OF THE DRAWINGS

FIG. 1 is a generic depiction of a transform of data from a flat structure such as a database table to a hierarchical target data structure.

FIG. 1A is a simplified flow chart showing steps of a method according to an embodiment.

FIG. 2 shows a specific example of a transform of data from a flat structure source data structure to a hierarchical target data structure.

FIG. 3 illustrates hardware of a special purpose computing machine which may be configured to employ target columns in data transformations in accordance with particular embodiments.

FIG. 4 is an example of a computer system.

### DETAILED DESCRIPTION

The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, examples and specific details are set forth in order to provide a thorough understanding of various embodiments of the present invention. It will be evident, however, to one skilled in the art that embodiments as defined by the claims may include some or all of the features in these examples alone or in combination with other features described below, and may further include modifications and equivalents of the features and concepts described herein.

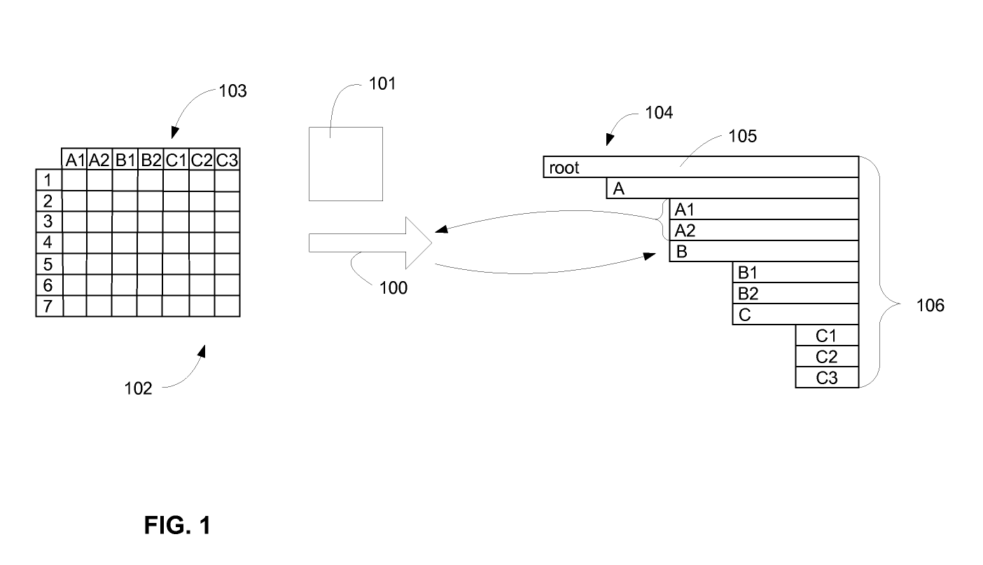

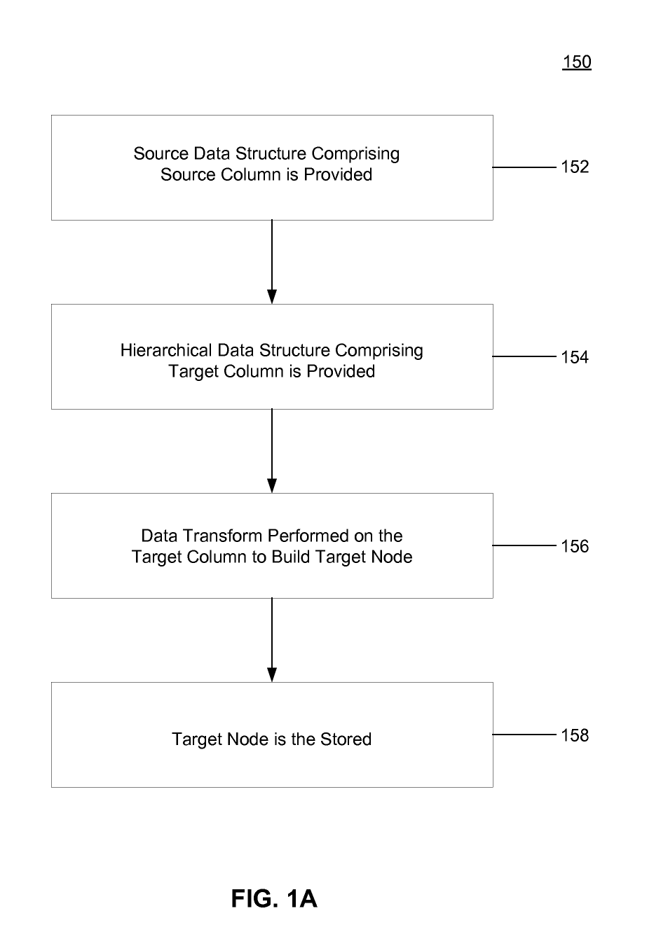

FIG. 1 is a generic depiction of a data transformation 100 as may be executed by a data transform engine 101. Specifically data that is organized according to a first (source) data structure 102 (here “flat” or non-hierarchical), may be transformed into a second (target) data structure 104 in which that data is organized according to a specific hierarchy 106. For example, the first data structure 102 comprises a plurality of source columns The second data structure 104 includes a root node 105 with child nodes (e.g. C1, C2, and C3) having data that is a subset of a higher-level parent data node (e.g. B).

In the particular example of FIG. 1, the first data structure 102 has seven (7) source columns 103, namely A1, A2, B1, B2, C1, C2 and C3. Since the first data structure 102 is flat, the table name is often omitted.

In the second data structure 104, there are also seven target columns, but they are at different levels in the hierarchy. Since this second data structure is hierarchical in nature, a full path is used to represent these columns Thus in this example of FIG. 1, the seven columns are:

root.A.A1, root.A.A2, root.A.B.B1, root.A.B.B2, root.A.B.C.C1, root.A.B.C.C2, and root.A.B.C.C3.

It has been discovered that when the target data structure of a transform is hierarchical in nature (as is the case in FIG. 1), use of the target columns as input columns in the same transform can be beneficial. In FIG. 1 this is shown by having the target column “root.A.A1” or “root.A.A2” or both of the node A, utilized as an input (together with the original input 102) to the transform to build the child node B. Similarly, columns under node A and B can be used as extra input to build child node C.

Such use of the target column as a transform input, may allow reuse of calculations already performed in the transform in order to avoid redundant processing. In addition, such use of target columns may enhance the expressiveness of the mapping logic of the transform.

FIG. 1A is a simplified flow chart showing steps of a method 150 according to an embodiment. In a first step 152, data stored according to a source data structure including a source column, is provided. In a second step 154, a hierarchical target data structure including a target column, is provided. In a third step 156, a data transform engine is caused to perform a transform on the data and the target column to build a target node of the hierarchical target data structure. In a fourth step 158, the target node is stored according to the hierarchical target data structure.

These and other concepts pertinent to various embodiments may be understood in connection with the following Example.

### EXAMPLE

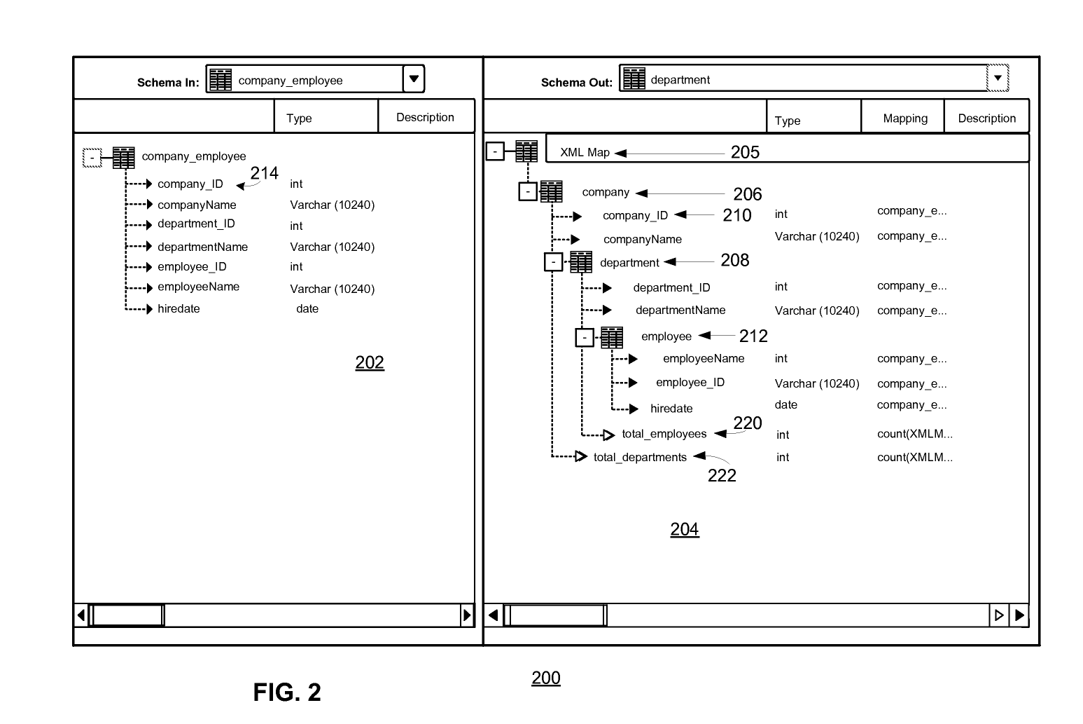

FIG. 2 shows a relatively simple data transformation 200, from a first, non-hierarchical data structure 202 to a second, hierarchical data structure 204. This transform illustrates the benefits of utilizing target columns in at least the following aspects.

Selection—the Where Clause

In this transform, the input data structure 202 is a list of employees from different companies. It is a flat data structure—that is, organized without hierarchies.

The output of this transform is the hierarchical data structure 204. Specifically, the root element 205 (“XMLMap”) contains a list 206 of unique companies (“company”). Each of the companies in turn contains a list of unique departments (“department”) belonging to that company. Each department in turn contains a list of employees (“employee”) belonging to that department.

For simplification, this example assumes that the target columns are directly mapped to the source columns That is, no functions are used.

In order to build the target document, each company, department, and employee node (all repeatable nodes) in the target must iterate through the same employee list.

To select a unique list of companies, a DISTINCT clause can be used. In this phase, a target column need not be relied upon yet, because the DISTINCT clause can be performed on the following source column: “company_employee.company_ID” 214.

Next, the departments belonging to each company are selected. This could be performed using something like a Where clause. However, without relying upon information in the target columns, the logic of such a Where clause would be difficult to formulate.

In particular, a separate transform would be needed to create a unique list of companies, and then that separate transform would be used as another input data set for the instant transform. Similarly, still another transform would be needed to create a unique list of departments (a combination of company/department), and eventually this transform would have three input data sets.

If, however, columns of the target data structure are used according to embodiments of the present invention, then the process becomes easier. For example, when the list of departments belonging to a given instance of a company node are selected, the target columns for that company have already been calculated and are available.

This is because the repeating structure “department” 208 (a table), is a child of the parent “company” node 206. Thus the identity of the company for which the list of departments is attempted to be selected, is already known.

So, in order to specify the Where clause (associated with the target “department” node 208), the following expression can be used:

company_employee.company_ID=XMLMap.company.company_ID

In this expression, the column “XMLMap.company.company_ID”, is a target column

Furthermore even if the target data structure were different from that shown in FIG. 2 (and the document processing order altered slightly), a target column could still be used according to an embodiment. For example, if the target data structure were modified so that the target column “company_ID” 210 under the node “company” 206, comes instead after the “department” node 208, it could still be determined at the time of compilation that this target column (“company_ID”) is used in some expressions in substructure (in this case, department). So the value for that target column could first be calculated, before instances for the “department” node were required to be built.

Similarly, to select the employee list that belongs to a particular department, the Where clause (associated with the employee node 212) can be specified as:

company_employee.company_ID=XMLMap.company.company_ID AND company_employee.department_ID=XMLMap.company.department.department_ID

Here, XMLMap.company.company_ID and XMLMap.company.department.department_ID are target columns

Uniqueness—the DISTINCT Clause

Also in this example of a data transform, a list of unique companies is to be created, and each of the companies contains a list of unique departments belonging to it. As explained above, to select the list of unique companies, a DISTINCT clause can be associated with the node “company” 206, and the source column “company_employee.company_ID” 214 can be used as the DISTINCT column.

But, the target column “XMLMap.company.company_ID” 210 could also be used as the DISTINCT column. In this manner, the data does not need to be retrieved twice from the input data set for the same source column: “company_employee.company_ID” 214. This is especially useful when the target column is mapped to the source columns using complex expression-like functions, because that same complex expression does not have to be evaluated twice.

It is noted that in standard SQL, the DISTINCT clause is performed on the result set (the target) to create a list of unique rows. This requires comparing all columns in the rows.

According to particular embodiments, this concept is now extended to allow the DISTINCT clause to be performed on specific columns The benefits of this can be seen in this example, in that to select a list of unique companies, only the company_ID is needed to be ensured to be unique.

Order by and Group By without Aggregation

As with the DISTINCT clause, using target columns in Order By and Group By (without aggregation), allows re-use of calculations (evaluation of mapping expressions).

Aggregation

In this particular example, the target structure comprises two aggregate columns
Under the node “company”, there is a column 220 called “totalDepartments”. It is supposed to hold the total number of departments in a company.
Under the node department, there is a column 222 called “totalEmployees”. It is supposed to hold the total number of employees in a department.

Absent use of target columns according to particular embodiments, it would be difficult to express the mapping logic to create the desired target structure. If, however, the target columns in the structure are used, the mapping logic can be expressed as follows:
The mapping expression for the column “totalDepartments”: count(XMLMap.company.department.department_ID)
The mapping expression for the column “totalEmployees”: count(XMLMap.company.departmentemployee.employee_ID)

This use of the target columns also provides runtime performance benefits. Specifically, when the list of employees for a given department (a target column) is built, at the same time the employees could be counted. Thus once the employee list is obtained for that department, the totalEmployees count would already be available and would not need to again be calculated separately. This is also true for the totalDepartments column

Regular Column Mapping

It may be possible to use target columns in the regular column mappings as well. This is because when creating instances for a child repeatable node, the target columns in the instance for current and the parent repeatable node are available (or can be evaluated).

However, the value of such an approach may be limited. After all, a target column is most likely mapped to one or more source columns, not other columns in the same structure.

Moreover, allowing unlimited use of target columns in the mappings may give rise to unintended consequences. For example, it will likely require alteration of the target node evaluation order (that is, document order). Users might therefore inadvertently create an infinite loop by referencing target columns to each other.

While the above description has focused upon performing a transform from a non-hierarchical source data structure to a hierarchical target data structure, this is not required in all embodiments. Particular embodiments may alternatively perform a transform from a hierarchical source data structure to a hierarchical target data structure.

And while the above description has focused upon performing a transform from a source data structure to a hierarchical target data structure, this is also not required in all embodiments. Particular embodiments may alternatively perform a transform to a non-hierarchical target data structure using a target column as an input, so as to order or to group the result set. Such embodiments could thus include the Order By and/or Group By functionalities.

In summary, it is proposed to use target columns in order to express certain query or mapping logics in a data services transform. This can be especially beneficial when the target structure is hierarchical.

Examples of one or more potential benefits of using target columns according to embodiments of the present invention include, but are not limited to:
making some otherwise difficult query/mapping scenarios easier to accomplish;
allowing expression of query/mapping logic in a single transform, thereby removing the need for multiple transforms for the runtime engine to build intermediate data structures between transforms;
allowing reuse of calculations in the transform.

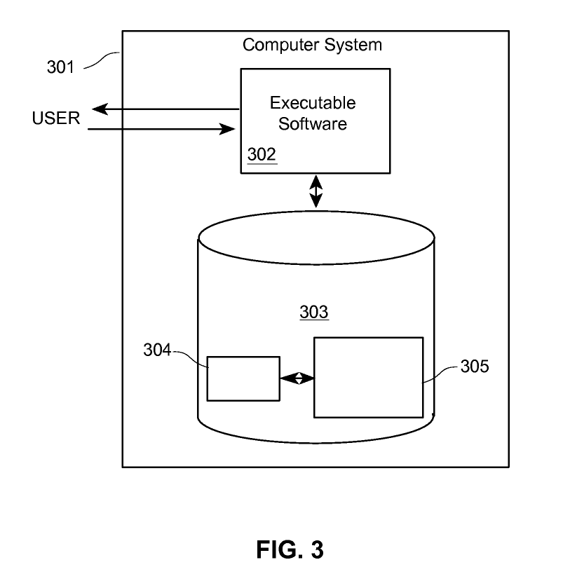

FIG. 3 illustrates hardware of a special purpose computing machine. This computing machine may be configured to employ target columns in data transformations in accordance with particular embodiments.

In particular, computer system 300 comprises a processor 302 that is in electronic communication with a non-transitory computer-readable storage medium 303. This computer-readable storage medium has stored thereon code 305 corresponding to the data stored in the source data structure that the subject of the transform. Code 304 corresponds to a data transformation engine that extract data from one or more sources, convert/transform it to another format, and then store that transformed data on a storage medium. The engine can also takes one or more incoming messages and transform or aggregate the messages to another message and send it to a target. Code may be configured to reference data stored in a database of a non-transitory computer-readable storage medium, for example as may be located in a remote database server or a file system.

Embodiments of data transform services may be run in conjunction with a computer system which may comprise a software server. A number of software servers together may form a cluster, or logical network of computer systems programmed with software programs that communicate with each other and work together to process requests.

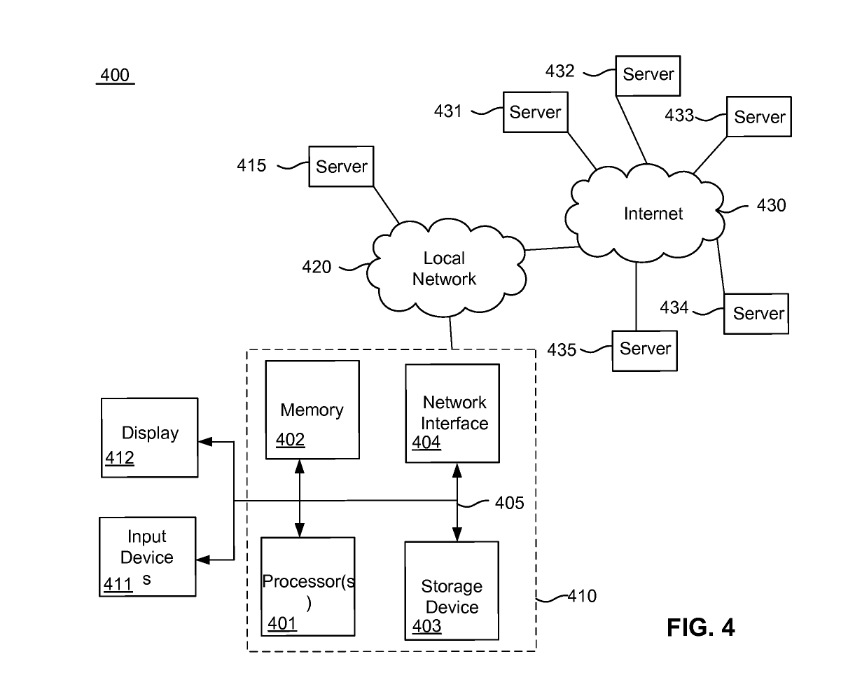

An example computer system 410 is illustrated in FIG. 4. Computer system 410 includes a bus 405 or other communication mechanism for communicating information, and a processor 401 coupled with bus 405 for processing information.

Computer system 410 also includes a memory 402 coupled to bus 405 for storing information and instructions to be executed by processor 401, including information and instructions for performing the techniques described above, for example. This memory may also be used for storing variables or other intermediate information during execution of instructions to be executed by processor 401. Possible implementations of this memory may be, but are not limited to, random access memory (RAM), read only memory (ROM), or both.

A storage device 403 is also provided for storing information and instructions.

Common forms of storage devices include, for example, a hard drive, a magnetic disk, an optical disk, a CD-ROM, a DVD, a flash memory, a USB memory card, or any other medium from which a computer can read.

Storage device 403 may include source code, binary code, or software files for performing the techniques above, for example. Storage device and memory are both examples of computer readable media. The computer system generally described in FIG. 4 includes at least those attributes described in FIG. 3.

Computer system 410 may be coupled via bus 405 to a display 412, such as a cathode ray tube (CRT) or liquid crystal display (LCD), for displaying information to a computer user. An input device 411 such as a touch screen, is coupled to bus 405 for communicating information and command selections from the user to processor 401. The combination of these components allows the user to communicate with the system. In some systems, bus 405 may be divided into multiple specialized buses.

Computer system 410 also includes a network interface 404 coupled with bus 405. Network interface 404 may provide two-way data communication between computer system 410 and the local network 420. The network interface 404 may be for Broadband Wireless Access (BWA) technologies. In any such implementation, network interface 404 sends and receives electrical, electromagnetic, or optical signals that carry digital data streams representing various types of information.

Computer system 410 can send and receive information, including messages or other interface actions, through the network interface 404 across a local network 420, an Intranet, or the Internet 430. For a local network, computer system 410 may communicate with a plurality of other computer machines, such as server 415. Accordingly, computer system 910 and server computer systems represented by server 415 may form a cloud computing network, which may be programmed with processes described herein.

In an example involving the Internet, software components or services may reside on multiple different computer systems 410 or servers 431-435 across the network. The processes described above may be implemented on one or more servers, for example. A server 431 may transmit actions or messages from one component, through Internet 430, local network 420, and network interface 404 to a component on computer system 410. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
providing data stored according to a source data structure including a source column;
providing a hierarchical target data structure including a target column;
causing a data transform engine to perform a transform on the data and the target column to build a target node of the hierarchical target data structure; and
storing the target node according to the hierarchical target data structure.

2. The method of claim 1 further comprising expressing a logic of the transform that uses the target column and the source column.

3. The method of claim 2 wherein the target column is included in a selection function, a uniqueness function, an ordering function, or an aggregate function.

4. The method of claim 3 wherein the selection function comprises a Where clause.

5. The method of claim 3 wherein the uniqueness function comprises a DISTINCT clause.

6. The method of claim 3 wherein the uniqueness function comprises an ORDER BY clause.

7. A non-transitory computer readable storage medium embodying a computer program for performing a method, said method comprising:
receiving data stored according to a source data structure including a source column;
receiving a hierarchical target data structure including a target column;
causing a data transform engine to perform a transform on the data and the target column to build a target node of the hierarchical target data structure; and
storing the target node according to the hierarchical target data structure.

8. The non-transitory computer readable storage medium of claim 7 wherein the method further comprises expressing a logic of the transform that uses the target column and the source column

9. The non-transitory computer readable storage medium of claim 8 wherein the target column is included in a selection function, a uniqueness function, an ordering function, or an aggregate function.

10. The non-transitory computer readable storage medium of claim 9 wherein the selection function comprises a Where clause.

11. The non-transitory computer readable storage medium of claim 9 wherein the uniqueness function comprises a DISTINCT clause.

12. The non-transitory computer readable storage medium of claim 9 wherein the uniqueness function comprises an ORDER BY clause.

13. A computer system comprising:
one or more processors;
a software program, executable on said computer system, the software program configured to:
receive data stored according to a source data structure including a source column;
receive a hierarchical target data structure including a target column;
cause a data transform engine to perform a transform on the data and the target column to build a target node of the hierarchical target data structure; and
store the target node according to the hierarchical target data structure.

14. The computer system of claim 13 wherein a logic of the transform is expressed using the target column and the source column

15. The computer system of claim 14 wherein the target column is included in a selection function, a uniqueness function, an ordering function, or an aggregate function.

16. The computer system of claim 15 wherein the selection function comprises a Where clause.

17. The computer system of claim 15 wherein the uniqueness function comprises a DISTINCT clause.

18. The computer system of claim 15 wherein the uniqueness function comprises an ORDER BY clause.
